(19) United States
(12) Patent Application Publication
(10) Pub. No.: US 2014/0240207 A1
(43) Pub. Date: Aug. 28, 2014

(54) LOW-POWER DISPLAY AND CORRESPONDING LIGHTING APPARATUS AND METHODS OF OPERATION

(71) Applicant: MOTOROLA MOBILITY LLC, Libertyville, IL (US)

(72) Inventors: Sen Yang, Palatine, IL (US); Xiaodong Xun, Hoffman Estates, IL (US); Zhiming Zhuang, Kildeer, IL (US)

(73) Assignee: MOTOROLA MOBILITY LLC, Libertyville, IL (US)

(21) Appl. No.: 13/778,823

(22) Filed: Feb. 27, 2013

(51) Int. Cl. G09G 3/00

(52) U.S. Cl. CPC G09G 3/00
USPC 345/82; 345/84

(57) ABSTRACT

A display (201) includes a light guide (314) defining a first major face (501), a second major face (502), and one or more edge surfaces (503,504). One or more light sources (315,316) are disposed along the one or more edge surfaces. A diffuser (313) is disposed adjacent to the first major face. A reflector (317) is disposed adjacent to the second major face. The second major face defines a plurality of convex protuberances (507) extending therefrom toward the reflector to direct light from the light guide to the reflector.

### BACKGROUND

1. Technical Field

This disclosure relates generally to displays, and more particularly to lighted displays.

2. Background Art

“Intelligent” portable electronic devices, such as smart phones, tablet computers, and the like, are becoming increasingly powerful computational tools. Moreover, these devices are becoming more prevalent in today's society. For example, not too long ago a mobile telephone was a simplistic device with a twelve-key keypad that only made telephone calls. Today, “smart” phones, tablet computers, personal digital assistants, and other portable electronic devices not only make telephone calls, but also manage address books, maintain calendars, play music and videos, display pictures, and surf the web.

As the capabilities of these electronic devices have progressed, so too have their user interfaces. Prior art physical keypads having a limited number of keys have given way to high resolution displays that sometimes serve as touch-sensitive user interfaces. As users have grown accustomed to using touch-sensitive displays to input data rather than physical keyboards, manufacturers have been incorporating larger and larger displays into their portable electronic devices. These larger displays, by nature, consume large amounts of power. Most of the displays are “backlit” in that they include a lighting source to project light through the display so as to make the display visible to a user in low-light environments.

It would be advantageous to have a display that is high resolution but that uses less power than prior art displays.

### BRIEF DESCRIPTION OF THE DRAWINGS

FIG. 1 illustrates a prior art electronic device having a prior art display.

FIG. 2 illustrates one explanatory electronic device having a display configured in accordance with one or more embodiments of the disclosure.

FIG. 3 illustrates a schematic block diagram of one explanatory display configured in accordance with one or more embodiments of the disclosure.

FIG. 4 illustrates an exploded view of one explanatory display configured in accordance with one or more embodiments of the disclosure.

FIG. 5 illustrates one explanatory light guide configured in accordance with one or more embodiments of the disclosure.

FIG. 6 illustrates an explanatory light guide being used in an explanatory display configured in accordance with one or more embodiments of the disclosure.

FIG. 7 illustrates one explanatory display being operated in accordance with one or more methods configured in accordance with one or more embodiments of the disclosure.

FIG. 8 illustrates one explanatory display being operated in accordance with one or more methods configured in accordance with one or more embodiments of the disclosure.

FIG. 9 illustrates one explanatory display being operated in accordance with one or more methods configured in accordance with one or more embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to a low power display and methods of operating the same. Any process descriptions or blocks in flow charts should be understood as representing modules, segments, or portions of code, which include one or more executable instructions for implementing specific logical functions or steps in the process. Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

It will be appreciated that embodiments of the disclosure described herein may be comprised of one or more conventional processors and unique stored program instructions that control the one or more processors to implement, in conjunction with certain non-processor circuits, some, most, or all of the functions of operating a display as described herein. The non-processor circuits may include, but are not limited to, a radio receiver, a radio transmitter, signal drivers, clock circuits, power source circuits, and user input devices. As such, these functions may be interpreted as steps of a method to perform display operation. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in figure other than figure A.

Embodiments of the invention provide a display having a light guide and light sources mounted on the sides of the light guide. A reflector is disposed on one side of the light guide. The light guide receives light from the light sources and delivers it to the reflector. The reflector reflects light back through the light guide to a user.

The first side of the light guide, in one embodiment, includes a plurality of convex protuberances that span the first side. The convex protuberances are configured to direct light received from the light sources to the reflector in a uniform manner. In contrast to prior art designs, embodiments of the disclosure orienting the convex protuberances toward the reflector advantageously result in a more uniformly lit overall display as perceived by a user.

In one embodiment, the other side of the light guide is configured with one or more light extractors. The light extractors receive light from the light sources and redirect it through the convex protuberances. Accordingly, the light extractors work to “catch” light that might be lost out of the second side of the light guide and to redirect that light to the reflector. One or more diffusers and/or brightness enhancement films can be disposed adjacent to the light guide on a side opposite the reflector as well to further enhance the uniformity of light being reflected from the reflector.

In one embodiment, a method of controlling a display backlighting system is configured to provide local dimming along a display to save power. The local dimming function cab be applied any of spatially, temporally, or combinations thereof. With temporal dimming, individual lights of the light sources can be controlled based upon the content of image that is being displayed on the display. The temporal dimming can be varied on a frame-by-frame basis. With spatial dimming, a single frame can be divided into several subsections. Individual lights can be turned ON and OFF within a single frame to control brightness, contrast, and definition of the image in addition to saving power. Where light sources are disposed on two sides of the light guide, subsections of the light sources can be actuated a section at a time to give rise to temporal dimming. The intensity of light being produced by the subsections of the light sources can be varied by varying a voltage or current being delivered to individual lights so that the two sides have different light intensities to achieve spatial dimming

Embodiments of the disclosure provide additional advantages over prior art designs. For example, when the display becomes large in a prior art mobile device, contrast problems arise. Most prior art displays employ a backlight that is continually ON and spans the entirety of the display. To create “black” colors, a LCD or other switchable layer attempts to block out the light being emitted by the backlight. This blocking is not entirely effective, which results in black areas looking grey. Accordingly, overall contrast is reduced. By using embodiments of the disclosure, independently actuating and/or dimming individual lights results in “blacker” blacks and “whiter” whites, thereby increasing contrast. Additionally, power consumption is reduced because the backlighting system is not continually ON.

Another advantage involves the “Z-stackup.” The Z-stackup refers to the vertical height from the front surface of a display to the rear surface of the display. With prior art displays, a backlighting element must be placed across the major face of the display, which makes the overall height thicker. This increased Z-dimension stackup height results in a thicker overall electronic device. By using a light guide configured in accordance with one or more embodiments of the disclosure, a thinner display results. Moreover, by disposing the convex protuberances toward the reflector, no loss of contrast control results despite the light guide being substantially thinner than in prior art designs. The use of individually controllable zones or subportions of the light sources further allows the Z-stackup to become even thinner. What's more, light guides configured in accordance with embodiments of the disclosure work to prevent light diffusion across zones or subsections of the display to further enhance contrast control.

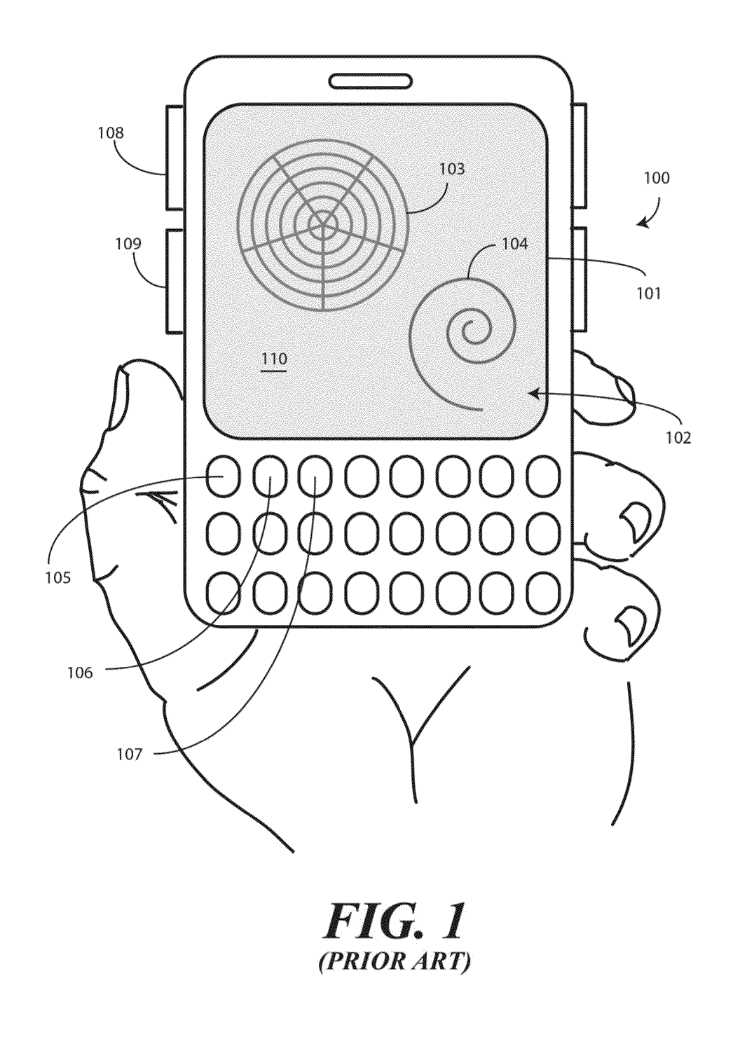

Turning first to FIG. 1, illustrated therein is a prior art electronic device 100 having a prior art display 101. The prior art display 101 includes a backlight that spans the face 102 of the prior art display 101. The backlight is always ON. A liquid crystal shutter layer is disposed atop the backlight. The liquid crystal layer includes pixels of liquid crystal molecules that are disposed between transparent electrodes. When a pixel is in a first state, light passes through the pixel. When the pixel is in a second state, light is blocked by a pixel.

While light gets blocked when a pixel is in the second state, due to the physical limitations of the liquid crystal media the light is not completely blocked. Consequently, shapes 103,104 that are supposed to appear black appear to be washed out or grey. Accordingly, the contrast between the shapes 103,104 and other colors, such as the white background 110, is poor. Moreover, since the backlight is always ON, the display becomes the most power hungry component in the prior art electronic device 100. Where the prior art electronic device 100 is a mobile phone, for example, the relatively large amounts of power consumed by the prior art display 101 result in lesser performance, reduced talk time, and quicker battery depletion.

The prior art electronic device 100 of FIG. 1 also includes conventional mechanical buttons 105,106,107 along a main face of the prior art electronic device 100 and mechanical keys 108,109 on the sides of the prior art electronic device 100. A user employs the mechanical buttons 105,106,107 and mechanical keys 108,109 to provide user input. The inclusion of the mechanical buttons 105,106,107 results in the available area for the prior art display 101 being relatively small. Despite its small size, the prior art display 101 still consumes large amounts of power due to the backlight being continually ON.

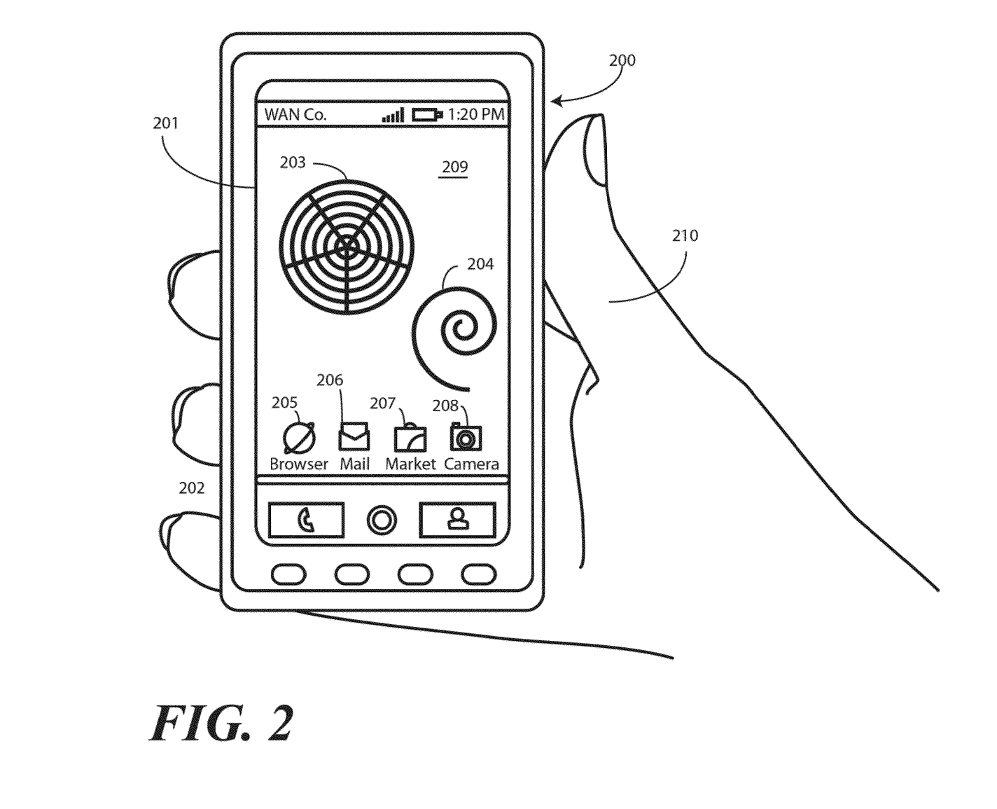

Turning now to FIG. 2, illustrated therein is one embodiment of an electronic device 200 configured in accordance with one or more embodiments of the disclosure. The explanatory electronic device 200 of FIG. 2 is shown as a smart phone for illustrative purposes. However, it will be obvious to those of ordinary skill in the art having the benefit of this disclosure that other electronic devices may be substituted for the explanatory smart phone of FIG. 2. For example, the electronic device 200 may be configured as a palm-top computer, a tablet computer, a gaming device, wearable computer, a media player, or other device.

A user 210 is holding the electronic device 200. The operating system environment, which is configured as executable code operating on one or more processors or control circuits of the electronic device 200, has associated therewith various applications or “apps.” Examples of such applications shown in FIG. 2 include a cellular telephone application 202 for making voice telephone calls, a web browsing application 205 configured to allow the user 210 to view webpages on the display 201 of the electronic device 200, an electronic mail application 206 configured to send and receive electronic mail, a shopping application 207 configured to permit a user to shop for goods and services online, and a camera application 208 configured to capture still (and optionally video) images. These applications are illustrative only, as others will be obvious to one of ordinary skill in the art having the benefit of this disclosure.

The display 201 of the electronic device 200 is configured in accordance with one or more embodiments of the disclosure. In one embodiment, the display 201 includes a light guide that defines a first major face, a second major face, and one or more edge surfaces. One or more light sources are disposed along the one or more edge surfaces to deliver light to the light guide through the one or more edge surfaces. A diffuser is disposed adjacent to the first major face and a reflector is disposed adjacent to the second major face. In one embodiment, the first major face is substantially planar and defines a plurality of light extractors to receive the light from the one or more light sources and redirect the light toward the reflector. In one embodiment, the second major face defines a plurality of convex protuberances extending from the second major face toward the reflector and spanning a major dimension of the second major face, each convex protuberance to direct the light from the light guide to the reflector.

By using the display 201 configured in this fashion, light elements of the light sources can be selectively turned OFF and ON. Further, the voltage or current applied to the light elements can be varied so as to selectively alter the amount of light being presented by each light element. Accordingly, there is no need to keep a large backlight continually ON as was the case in the prior art electronic device (100). This results in reduced power consumption. The reduced power consumption occurs despite the fact that the display 201 of FIG. 2 is configured as a touch-sensitive display and is nearly twice the size of the prior art display (101) of FIG. 1. Moreover, the selective actuation and light control of the light elements, combined with the physical configuration of the display 201, results in shapes 203,204 that are supposed to be black actually being perceived to be that color by a user. Further, the difference between the black color of the shapes 203,204 and the white background 209 is stark and different. By comparing the views of FIG. 1 and FIG. 2 side-by-side, it becomes self evident that the contrast offered by the display 201 of FIG. 2 is far superior to that shown in FIG. 1.

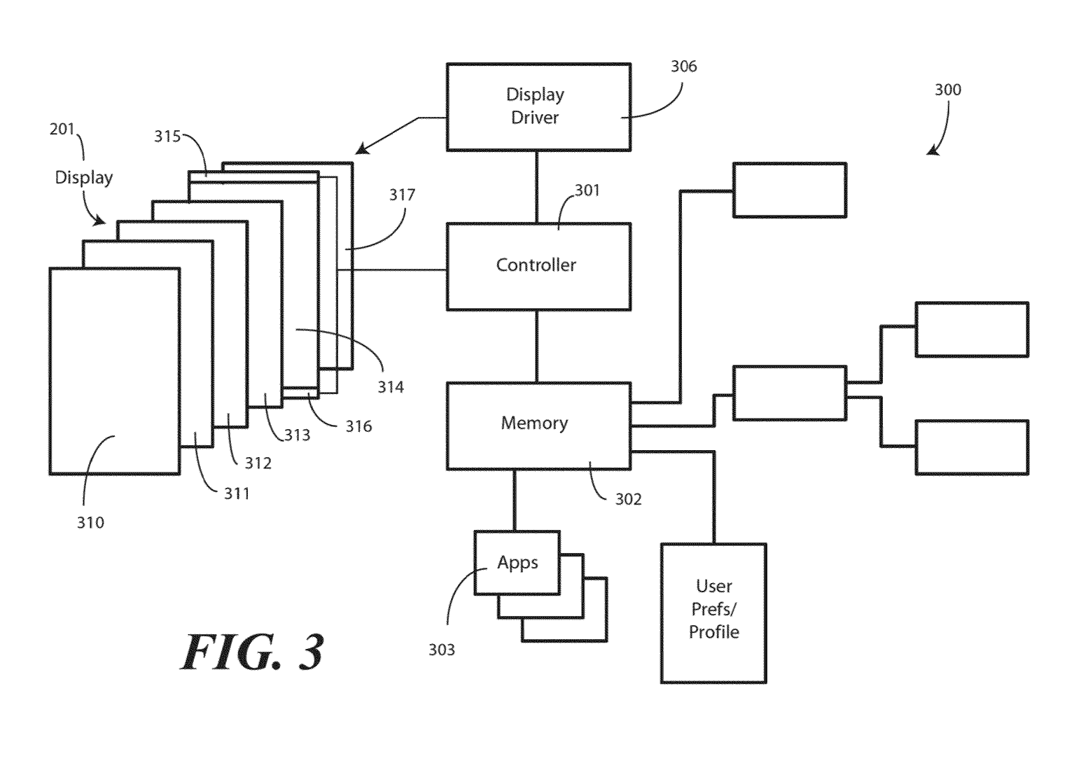

Turning now to FIG. 3, illustrated therein is the electronic device (200) shown as a schematic block diagram 300. The schematic block diagram 300 illustrates one embodiment of internal circuitry, software modules, firmware modules, and other components in an electronic device (200) in accordance with embodiments of the disclosure. While this illustrative internal circuitry is directed to a generic electronic device, note that it could be readily adapted to any number of specific devices.

As shown in the schematic block diagram 300, a control circuit 301 is operable with the display 201, which is touch-sensitive in this illustrative embodiment. The control circuit 301, which may be a microprocessor, programmable logic, application specific integrated circuit device, or other similar device, is capable of executing program instructions, such as those that will be described with reference to the methods discussed below. The program instructions may be stored either in the control circuit 301 or in a memory 302 or other computer readable medium operable with the control circuit 301. The memory 302 can also store executable code corresponding to the various applications 303 that are operable on the electronic device (200), such as those described above with reference to FIG. 2. The control circuit 301 is configured, in one embodiment, to operate the various functions of the electronic device (200). The control circuit 301 can execute software or firmware applications stored in memory 302 to provide device functionality. In one embodiment, the control circuit 301 is configured to be operable with a display driver 306 to effect and control presentation of information on the display 201.

Coupled to, and operable with, the controller is the display 201. The explanatory display 201 of FIG. 3 is touch-sensitive and is shown as a plurality of layers. While this is one embodiment of a touch sensitive display, it will be clear to those of ordinary skill in the art having the benefit of this disclosure that embodiments of the disclosure are not so limited. Numerous other touch sensitive surfaces can be substituted without departing from the spirit and scope of the disclosure.

In the illustrative embodiment of FIG. 3, the six layers of the display 201 are shown. Starting from the top, a fascia layer 310 is provided. The fascia layer 310 may be manufactured from glass or a thin film sheet, and can serve as a unitary fascia member for the electronic device. As used herein, a “fascia” is a covering or housing, which may or may not be detachable. Suitable materials for manufacturing the cover layer include clear or translucent plastic film, glass, plastic, or reinforced glass. Reinforced glass can comprise glass strengthened by a process such as a chemical or heat treatment. The fascia layer 310 may also include a ultra-violet barrier. Such a barrier is useful both in improving the visibility of display 201 and in protecting internal components of the electronic device.

Beneath the fascia layer 310 is the capacitive touch sensor layer 311. The capacitive touch sensor layer 311, which can be constructed by depositing small capacitive plate electrodes on a transparent substrate, is configured to detect the presence of an object, such as a user's finger or stylus, near to or touching the display 201. Circuitry operable with or disposed within the control circuit 301 is configured to detect a change in the capacitance of a particular plate combination on the capacitive touch sensor layer 311. The capacitive touch sensor layer 311 may be used in a general mode, for instance to detect the general proximate position of an object relative to the touch sensitive display. The capacitive touch sensor layer 311 may also be used in a specific mode, where a particular capacitor plate pair may be detected to detect the precise location of an object along length and width of the touch sensitive display. Note that the capacitive touch sensor layer 311 is a particular implementation of an electromagnetic field sensor, and other types of electromagnetic field sensors, such as a magnetic field sensor, can replace the capacitive field sensor.

Note that while the capacitive touch sensor layer 311 and the fascia layer 310 are shown as separate layers in FIG. 3 for illustrative purposes, in many embodiments they will be integrated into a single element to achieve a thinner overall form factor of the electronic device (200). Accordingly, in one embodiment the capacitive touch sensor layer 311 is integrated with the fascia layer 310 by depositing the capacitor plate electrodes of the capacitive touch sensor layer 311 directly upon the fascia layer 310. For example, indium tin oxide defining the capacitor plate electrodes can be laminated directly to the underside of the fascia layer 310.

Beneath the capacitive touch sensor layer 311 are, optionally, one or more layers of brightness enhancement film 312. Brightness enhancement films 312 are polymer film sheets that include an imprinted prismatic surface pattern to diffuse light. It has been said that the prismatic surface pattern, when viewed closely, resembles a series of triangles or gear teeth extending distally from the surface of the sheet. Each of these prisms redirects light passing out of the display 201 toward the viewer. Without the brightness enhancement film 312, some of the light emitted by the display 201 may not be available to the viewer due to the fact that the angle at which the light exits the display 201 is above or below a viewer's field of view. The brightness enhancement film 312 works to collimate the light toward the user's field of view. Such brightness enhancement films 312 are available from 3M Corporation, for example.

It should be noted that the brightness enhancement film 312 can comprise one or more layers of film. For example, in one embodiment, the brightness enhancement film 312 can comprise two layers of film, or alternatively can comprise a dual brightness enhancement film. A second layer of film can provide a reflective sheet to recycle any light that fails to intersect a prism of the primary layer at the appropriate angle for collimation. Where multiple layers are use, light either passes through the prisms to the user's field of view or else “bounces” between the reflector 317 until it reaches a prism of the primary layer at the proper angle. A single sheet of brightness enhancement film 312 can increase brightness of the display by as much as 605, while two sheets disposed orthogonally relative to each other can provide up to a 120% increase in brightness. As will be appreciated by those of ordinary skill in the art having the benefit of this disclosure, the use of the brightness enhancement film 312 allows the light sources 315,316 to decrease the amount of power consumed to deliver a specified amount of display brightness.

Beneath the optional brightness enhancement film 312, in one embodiment, is a diffuser 313. The diffuser 313, in one embodiment, is a layer that diffuses, spreads, or scatters received light to soften the same. The diffuser 313 can be constructed from glass or plastic.

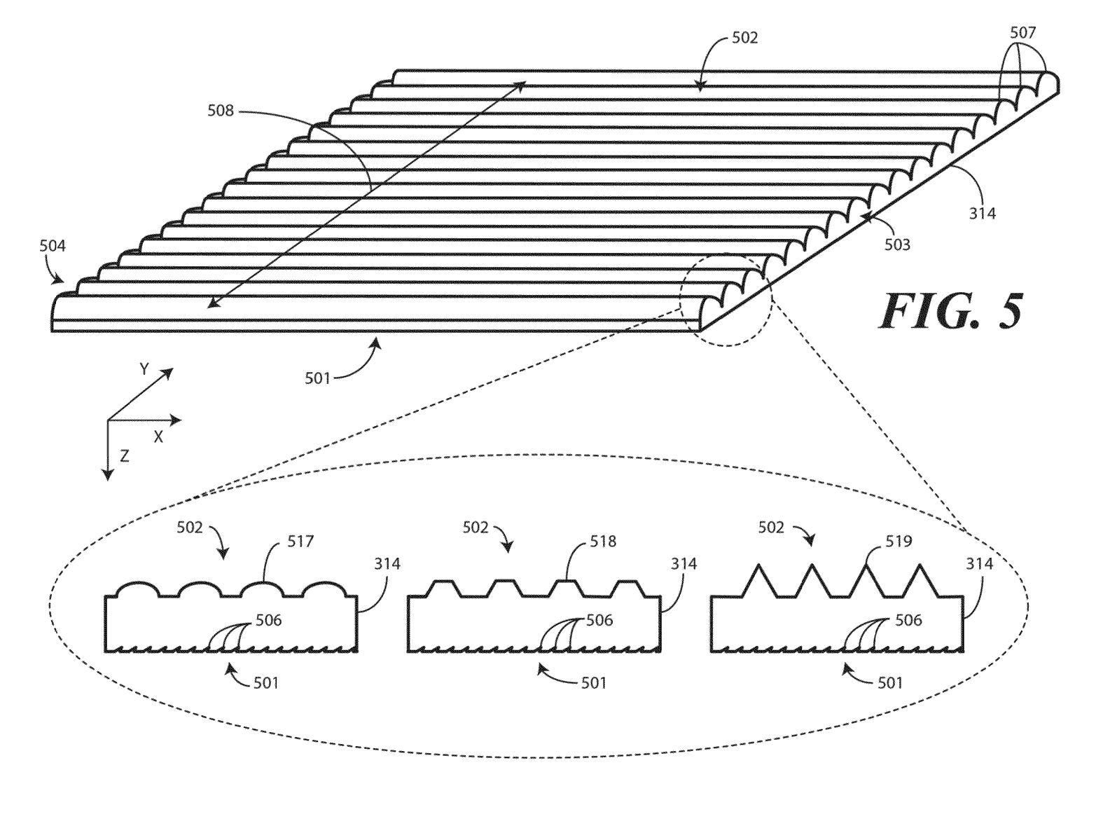

Disposed beneath the diffuser 313 is a light guide 314. Details of the light guide 314 will be explained in more detail with reference to FIG. 5 below. In one embodiment, the light guide 314 defines a first major face, a second major face, and one or more edge surfaces. In one embodiment, the first major face is substantially planar and defines a plurality of light extractors that are configured to receive the light from one or more light sources 315,316 and redirect the light toward a reflector 317. In one embodiment, the second major face of the light guide 314 defines a plurality of convex protuberances extending from the second major face toward the reflector 317 and spanning a major dimension of the second major face. Each convex protuberance is configured to direct the light from the light guide 314 to the reflector 317.

Disposed adjacent to the light guide 314 are one or more light sources 315,316. In the illustrative embodiment of FIG. 3, the light sources 315,316 comprise two light sources disposed along one or more edge surfaces of the light guide 214 to deliver light to the light guide 314 through the one or more edge surfaces. The light sources 315,316 are disposed in this illustrative embodiment on opposite, i.e., non-adjoining, edge surfaces such that they project light into the light guide 314 towards each other.

Beneath the light guide 314 is the reflector 317. In one embodiment, the reflector 317 is configured to reflect light delivered to the reflector 317 by the plurality of convex protuberances extending from the light guide 314 toward the reflector 317. The reflector 317 can then return the light to the light guide 314. The reflector 317 can be disposed adjacent the light guide 314 and can be manufactured from a reflective material such as polyethylene terephthalate in one embodiment.

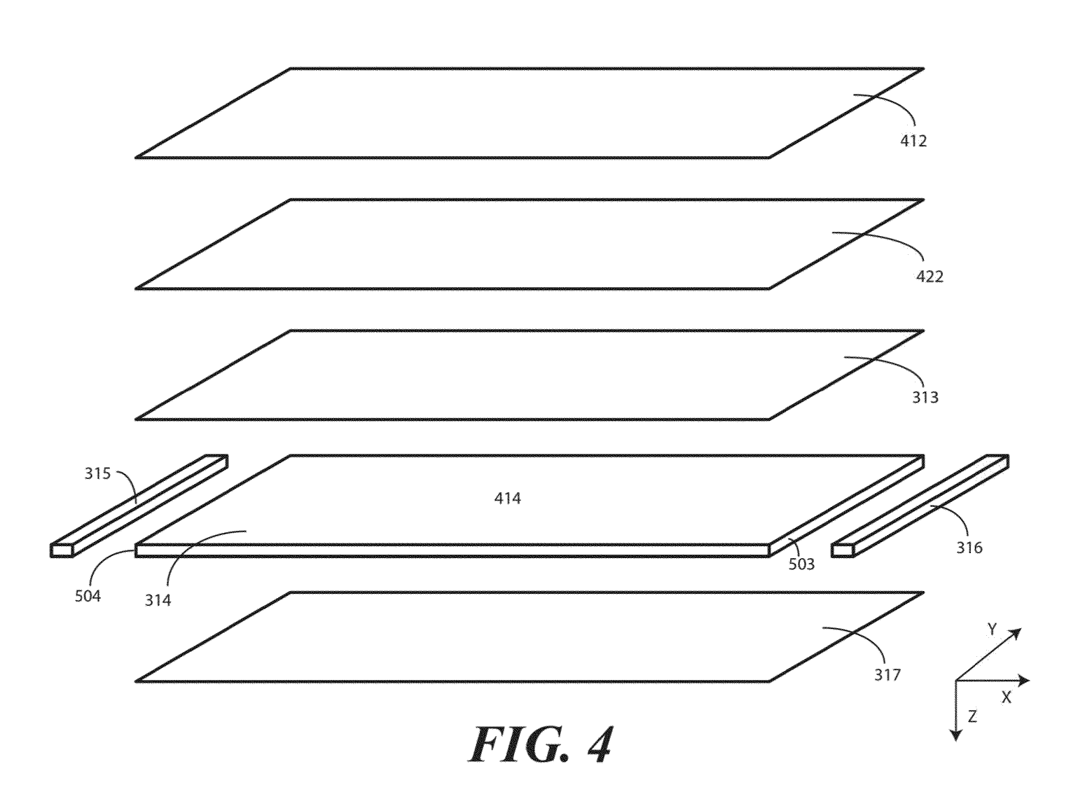

FIG. 4 shows an exploded view of the layers of the display (201) disposed beneath the capacitive touch sensor layer (311). In this illustrative embodiment, the brightness enhancement film (312) comprises a first brightness enhancement film layer 412 and a second brightness enhancement film layer 422. In this illustrative embodiment, the first brightness enhancement film layer 412 is disposed adjacent to the second brightness enhancement film layer 422 on a side of the second brightness enhancement film layer 422 that is opposite, i.e., facing away from, the diffuser 313.

As described above, the second brightness enhancement film layer 422 includes an imprinted prismatic surface pattern to diffuse light. Illustrating by example, in one embodiment the brightness enhancement film layers 412,422 each comprise a prismatic structure disposed along the surface thereof. The prismatic surface pattern of the second brightness enhancement film layer 422 collimates received light toward the user's field of view. The first brightness enhancement film layer 412, having another prismatic structure oriented substantially orthogonally relative to the prismatic structure of the second brightness enhancement film layer 422, provides a reflective function to recycle any light that fails to intersect a prismatic structure of the primary layer at the appropriate angle for collimation.

The diffuser 313 is disposed below the brightness enhancement film layers 412,422. In this illustrative embodiment, the brightness enhancement film layers 412,422 are disposed adjacent to the diffuser 313 on a side of the diffuser 313 that is opposite, i.e., facing away from, the reflector 317. The two brightness enhancement film layers 412,422 are configured in one embodiment to diffuse the light passing from the light guide 314 through the diffuser 313.

The light guide 314 is disposed beneath the diffuser 313. Turning briefly to FIG. 5, illustrated therein is one explanatory light guide 314 configured in accordance with one or more embodiments of the disclosure in more detail.

As shown in FIG. 5, in one embodiment the light guide 314 defines a first major face 501, a second major face 502, and one or more edge surfaces 503,504. As shown in the exploded sectional view 505, in one embodiment the first major face 501 is substantially planar and defines one or more light extractors 506. In this illustrative embodiment, each light extractor 506 defines an indentation extending into the light guide 314 from the first major face 501. In the illustrative embodiment of FIG. 5, each indentation defines a triangular cross section. Other cross sectional shapes for the indentations will be obvious to those of ordinary skill in the art having the benefit of this disclosure.

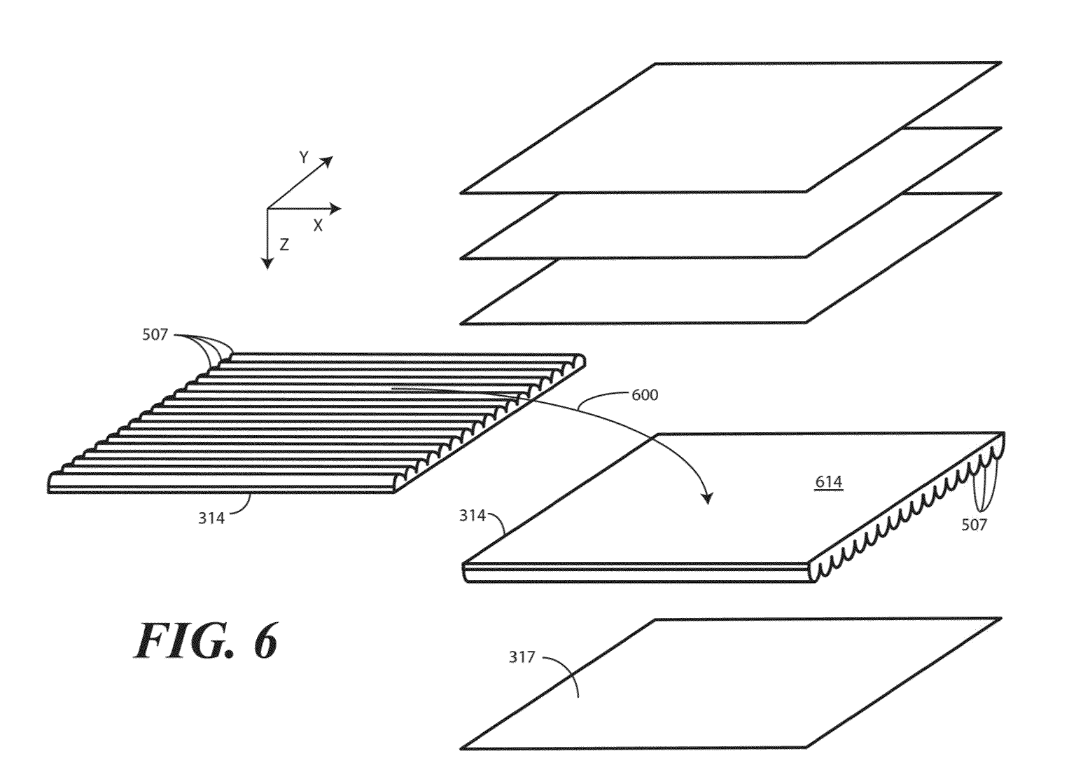

The second major face 502 defines a plurality of convex protuberances 507 extending from the second major face 502 and spanning a major dimension 508 of the second major face 502. As will be shown below in the discussion of FIG. 6, in one embodiment the plurality of convex protuberances 507 are oriented, in one embodiment, so as to extend toward the reflector 317 to direct the light from the light guide 314 to the reflector 317. In one embodiment, the plurality of convex protuberances 507 are arranged in linear rows spanning the second major face 502 of the light guide 314.

The cross section of each of the plurality of convex protuberances 507 can take a variety of shapes. For example, convex protuberances 517 define a portioned disc cross section. Convex protuberances 527 define a frustoconical cross section. Convex protuberances 537 define a triangular cross section. These shapes of cross sections are illustrative only. Other cross section shapes will be obvious to those of ordinary skill in the art having the benefit of this disclosure.

In one or more embodiments, the light guide 314 can be formed in a substantially tabular shape. In one or more embodiments, the first major face 501 and the second major face 502 can be formed in a substantially rectangular shape. In one or more embodiments, the light guide 314 can be made of a transparent resin such as an acrylic resin, polycarbonate resin, and so forth. The one or more edge surfaces 503,504 can be configured to operate as the light incident surfaces to receive light emitted from the one or more light sources 315,316. Accordingly, a respective one of the one or more edge surfaces 503,504 can be located so as to face each of the one or more light sources as shown in FIG. 4.

As the terms are used herein, a direction orthogonal to the one or more edge surfaces 503,504 of the light guide 314 may be referred to as the X-axis direction. A longitudinal direction of the one or more edge surfaces 503,504 of the light guide 314 may be referred to as the Y-axis direction, and a direction perpendicular to the second major face 502 may be referred to as the Z-axis direction, as shown in FIG. 5.

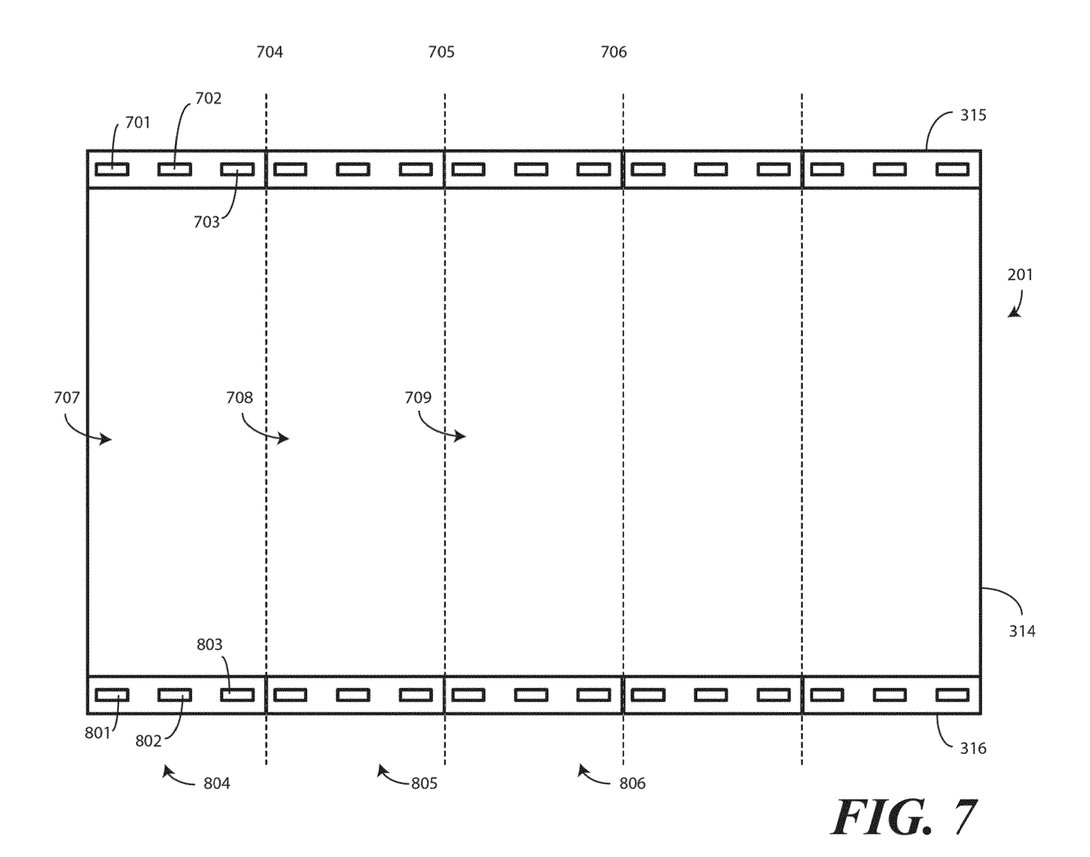

Turning back to FIG. 4, one or more light sources 315,316 are disposed along the one or more edge surfaces 503,504 of the light guide 314 to deliver light to the light guide 314 through the one or more edge surfaces 503,504. In one embodiment, each of the one or more light sources 315,316 comprises light emitting diodes. In one embodiment, the light emitting diodes are arranged in groups. In one embodiment, the groups are configured such that the light emitting diodes of some groups emit the light into the light guide 314 independently of other groups. This will be shown in more detail with reference to FIGS. 7-9 below. In one embodiment, the one or more light sources 315,316 comprise a first light source 315 disposed adjacent to a first edge surface 504 of the light guide 314 and a second light source 316 disposed adjacent to a second edge surface 503 of the light guide 314 opposite a major face 414 of the light guide 314 from the first edge surface 504.

Turning now to FIG. 6, illustrated therein is a display 201 configured in accordance with one or more embodiments of the disclosure. The exploded view of the display 201 illustrates the orientation of the light guide 314 is one or more embodiments. In one embodiment the plurality of convex protuberances 507 are configured to direct light from the one or more light sources (315,316) toward the reflector 317. Accordingly, while the light guide 314 was shown with the plurality of convex protuberances 507 pointing in the negative Z direction, in one embodiment the light guide 314 gets flipped 600 over so that the plurality of convex protuberances 507 point in the Z direction toward the reflector 317. This places the plurality of light extractors (506) on the major face 614 disposed opposite the major face upon which the plurality of convex protuberances 507 are disposed. This causes the plurality of convex protuberances 507 to direct received light toward the reflector 317, which in turn advantageously results in a more uniform display with better contrast characteristics than in prior art displays having prismatic structures oriented in other directions, e.g., extending from the light guide 314 in the negative Z direction.

Turning now to FIGS. 7-9, illustrated therein are explanatory operational modes of one or more displays configured in accordance with one or more embodiments of the disclosure. Beginning with FIG. 7, as shown in this plan view, in one embodiment each of the one or more light sources 315,316 each comprise light emitting diodes 701,702,703,801,802,803 arranged in groups 704,705,706,804,805,806 to emit the light into the light guide 314. In one embodiment, the groups 704,705,706,804,805,806 are configured such that some groups, e.g., groups 704,706,805, can be actuated, dimmed, and/or controlled independently of other groups, e.g., groups 705,804. A control circuit 301, which is operable with the light sources 315,316 in conjunction with a display driver 306, can be configured to actuate the groups 704,705,706,804,805,806 spatially and temporally to control a perceived brightness of the display 201.

As noted above, temporal control can include altering a voltage or current applied to an individual light emitting diode to dim or actuate/deactuate one or more individual light emitting diodes 701,702,703,801,802,803. In one embodiment, this control can be based upon the content being presented on the display 201. Further, this control can occur on a frame-by-frame basis. For example, if the content being presented on the display 201 is a video being shown at a frame rate of 60 frames per second, the temporal control can occur such that the amount of light emitted by the light emitting diodes 701,702,703,801,802,803 changes sixty or more times per second.

With spatial control, the control circuit 301 is configured to apply dimming and/or lighting control to the groups 704,705,706,804,805,806. Individual groups 704,705,706,804,805,806 can be selectively actuated during an individual frame to control brightness and contrast. For example, group 704 can be OFF while groups 704,805,806 are ON, with groups 704,806 being brighter than group 805. Of course, a combination of spatial and temporal control can be used as well.

In addition to spatial and temporal actuation, in one embodiment the control circuit 301 can be configured to actuate the light emitting diodes 701,702,703,801,802,803 or groups 704,705,706,804,805,806 sequentially as well by actuating light emitting diodes 701,702,703,801,802,803 or groups 704,705,706,804,805,806 before another of the light emitting diodes 701,702,703,801,802,803 or groups 704,705,706,804,805,806 disposed adjacent to the first. For example, light emitting diode 701 can be actuated before light emitting diode 702. Similarly, group 704 can be actuated before group 705, and so forth.

In one embodiment, the groups 704,705,706,804,805,806 are arranged in pairs on opposite sides of the light guide 314. For example, groups 704,804 define one pair, while groups 705,805 define another pair, and so forth. In one embodiment, each pair is disposed on opposite sides of the light guide 314 so as to define one or more predefined zones 707,708,709.

The control circuit 301 can be configured to actuate selected pairs in a first mode by turning ON a first pair corresponding to a first predefined zone, e.g., predefined zone 707, while turning OFF a second pair corresponding to a second predefined zone, e.g., predefined zone 708. Further, the control circuit 301 can also actuate the pairs in a second mode in corresponding zones by of actuating a first member of the pair, e.g., group 704, to emit more light into a predefined zone 707 than another member of the pair, e.g., group 804. Of course, combinations of the first mode and the second mode to control the predefined zones 707,708,709 can be used as well. In one or more embodiments, the first mode and second mode control of the pairs along the predefined zones 707,708,709 can be based upon frames of content received by the control circuit 301.

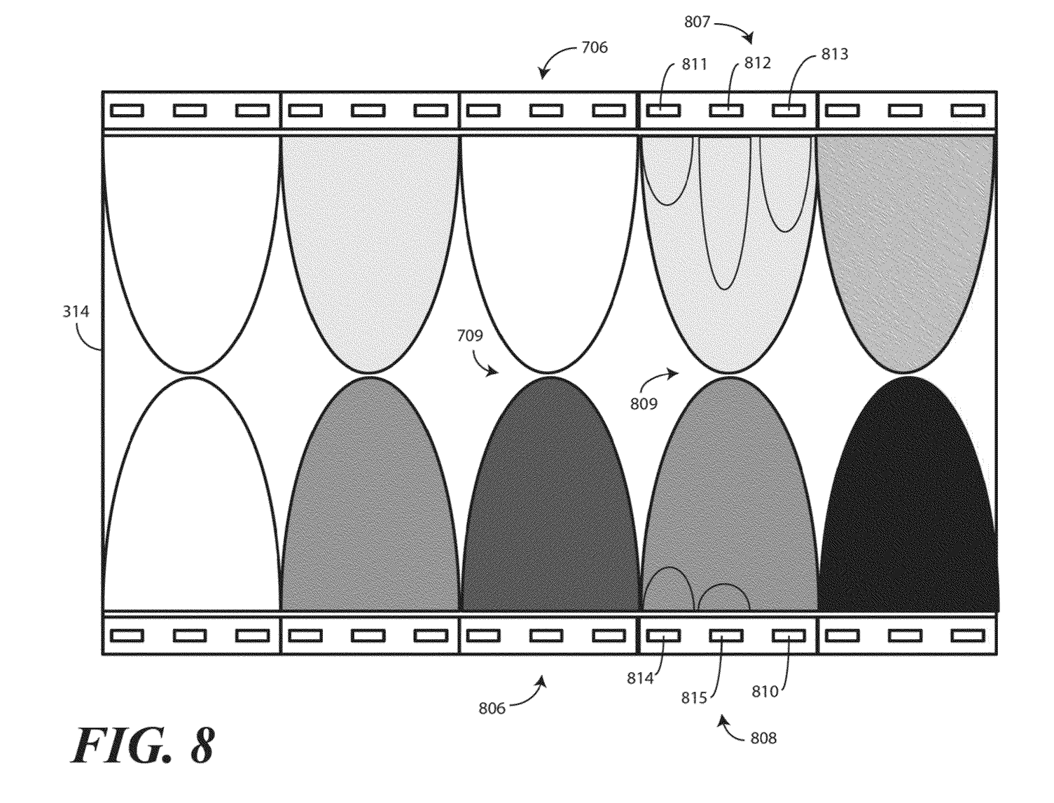

Turning now to FIG. 8, illustrated therein are a few examples of the spatial and temporal control. Spatial control can be seen in that group 706 is ON, while group 806 is OFF. Note that this is also an example of first mode zone control, as group 706 and group 806 are disposed opposite the light guide 314 relative to each other so as to define predetermined zone 709. Temporal control can be seen as individual light emitting diodes 811,812,813,814,815,810 are all being dimmed to levels that are different and distinct from levels being output by other light emitting diodes. For example, light emitting diode 812 is emitting the most light, while light emitting diode 813 is emitting less light. Light emitting diode 810 is OFF. Note that this is an example of second mode zone control, as group 807 and group 808 are disposed on opposite sides of the light guide 314 so as to define predetermined zone 809.

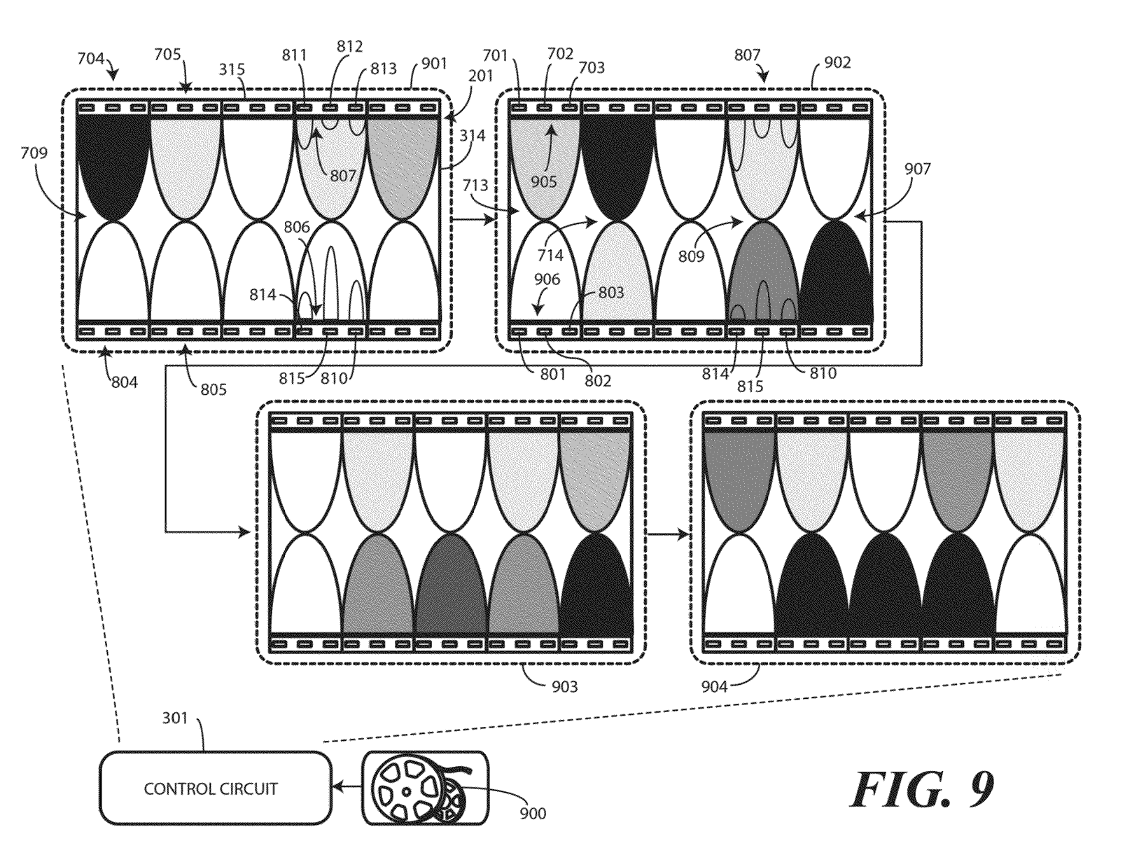

Turning now to FIG. 9, illustrated therein is the control circuit 301 controlling the display 201, or more particularly the one or more light sources 315,316 of the display 201, based upon frames 901,902,903,904 of content 900. In this illustrative embodiment, the content 900 is a video show being rendered at 60 frames per second. Accordingly, frame 901 occurs for 1160^{th} of a second, while frame 902 occurs for 1160^{th} of a second, and so forth. Note that 60 frames per second is an illustrative frame rate only, and that others will be obvious to those of ordinary skill in the art having the benefit of this disclosure. For example, a 50 frame per second frame rate could be used as well.

The brightness and contrast of each frame 901,902,903,904 is being controlled spatially and temporally. Additionally, the brightness and contrast of each frame 901,902,903,904 is being controlled using the first mode and second mode corresponding to predefined zones as well. Illustrating this by example, in the first frame 901, spatial control can be seen in that group 704 is OFF, while group 804 is ON. Note that this is also an example of first mode zone control, as group 706 and group 806 are disposed opposite the light guide 314 relative to each other so as to define predetermined zone 709. Temporal control can be seen as individual light emitting diodes 811,812,813,814,815,810 are all being dimmed to levels that are different and distinct from levels being output by other light emitting diodes. Note that this is an example of second mode zone control, as group 807 and group 808 are disposed on opposite sides of the light guide 314 so as to define predetermined zone 809.

This all changes in frame 902 due to the changes in the content 900. In the first frame 901, in predefined zone 713, second mode zone control is occurring because group 905 is being driven to a different brightness output from group 906. In predefined zone 714, first mode zone control is occurring. Temporal control of light emitting diodes 811,812,813,814,815,810 is occurring in predetermined zone 809. Spatial control is occurring in zone 907. As shown, any of spatial control, temporal control, first mode zone control, or second mode zone control can occur, alone or in combination, on a frame-by-frame basis based upon the content 900. The control occurring in each frame 901,902,903,904 is different in FIG. 9.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims. Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A display, comprising:
a light guide defining a first major face, a second major face, and one or more edge surfaces;
one or more light sources disposed along the one or more edge surfaces to deliver light to the light guide through the one or more edge surfaces;
a diffuser disposed adjacent to the first major face; and
a reflector disposed adjacent to the second major face;
the first major face being substantially planar and defining a plurality of light extractors to receive the light from the one or more light sources and redirect the light toward the reflector; and
the second major face defining a plurality of convex protuberances extending from the second major face toward the reflector and spanning a major dimension of the second major face, each convex protuberance to direct the light from the light guide to the reflector.

2. The display of claim 1, the each convex protuberance defining a triangular cross section.

3. The display of claim 1, the each convex protuberance defining a frustoconical cross section.

4. The display of claim 1, the each convex protuberance defining a portioned disc cross section.

5. The display of claim 1, the each extractor of the plurality of light extractors defining an indentation extending into the light guide from the first major face.

6. The display of claim 5, the indentation defining a triangular cross section.

7. The display of claim 1, further comprising a layer of brightness enhancement film disposed adjacent to the diffuser opposite the reflector, the layer of brightness enhancement film to diffuse the light passing from the light guide through the diffuser.

8. The display of claim 7, further comprising another layer of brightness enhancement film disposed adjacent to the layer of brightness enhancement film opposite the diffuser.

9. The display of claim 8, the layer of brightness enhancement film comprising a prismatic structure, the another layer of brightness enhancement film comprising another prismatic structure, the prismatic structure and the another prismatic structure being oriented orthogonally relative to each other.

10. The display of claim 1, the one or more light sources each comprising light emitting diodes arranged in groups to emit the light into the light guide independently of other groups, further comprising a control circuit operable with the one or more light sources to actuate the groups spatially and temporally to control a perceived brightness of the display.

11. An electronic device, comprising:
a display, comprising:
a light guide defining a plurality of convex protuberances extending from a major face of the light guide, each convex protuberance to direct light away from the light guide;
one or more light sources disposed along one or more edge surfaces of the light guide to deliver light to the light guide through the one or more edge surfaces, each of the one or more light sources comprising light emitting diodes arranged in groups to emit the light into the light guide independently of other groups;
a diffuser disposed adjacent to the light guide; and
a reflector disposed adjacent to the light guide opposite the diffuser;
a control circuit, operable with the display, to actuate at least some of the groups spatially and at least some light sources temporally to control a perceived brightness of the display.

12. The electronic device of claim 11, another major face defining a plurality of light extractors to receive the light from the one or more light sources and redirect the light.

13. The electronic device of claim 11, the each convex protuberance to direct the light from the light guide to the reflector.

14. The electronic device of claim 11, the one or more light sources comprising a first light source disposed adjacent to a first edge surface of the light guide and a second light source disposed adjacent to a second edge surface of the light guide opposite the major face from the first edge surface.

15. The electronic device of claim 11, the groups and other groups being arranged in pairs on opposite sides of the light guide, each pair being disposed along a predefined zone of the light guide, the control circuit to actuate the pairs in a first mode by turning ON a first pair corresponding to a first zone while turning OFF a second pair corresponding to a second zone.

16. The electronic device of claim 15, the control circuit to actuate the pairs in a second mode by of actuating a first member of the pair to emit more light into a zone than another member of the pair.

17. The electronic device of claim 16, the control circuit to actuate the at least some groups spatially and the at least some light sources temporally based upon frames of content received by the control circuit.

18. The electronic device of claim 15, the control circuit to further actuate the pairs sequentially by actuating the first pair before the second pair disposed adjacent to the first pair.

19. The electronic device of claim 11, the plurality of convex protuberances being arranged in linear rows spanning the major face of the light guide.

20. An electronic device, comprising:
a display, comprising:
a reflector;
a light guide defining a plurality of convex protuberances extending from a major face of the light guide, each convex protuberance to direct light away from the light guide toward the reflector;
one or more light sources disposed along one or more edge surfaces to deliver light to the light guide through the one or more edge surfaces of the light guide; and
a diffuser disposed adjacent to the light guide opposite the reflector;
another major face of the light guide being substantially planar and defining one or more light extractors to receive the light from the one or more light sources and redirect the light toward the plurality of convex protuberances; and
a control circuit, operable with the display, to actuate the one or more light sources to control a perceived brightness of the display.
